(19) United States
(12) Patent Application Publication
(10) Pub. No.: US 2020/0139284 A1
(43) Pub. Date: May 7, 2020

(54) FILTER HOUSING ASSEMBLY

(71) Applicant: Laboratories Merck Sharp & Dohme-Chibret, Courbevoie (FR)

(72) Inventors: Bertrand Pessaud, Clermont-Ferrand (FR); Michael Meyer, Cebazat (FR)

(73) Assignee: Laboratories Merck Sharp & Dohme-Chibret, Courbevoie (FR)

(21) Appl. No.: 16/180,374

(22) Filed: Nov. 5, 2018

(51) Int. Cl. B01D 46/00; B01D 29/11; B01D 29/00

(52) U.S. Cl. CPC B01D 46/0002; B01D 29/114; B01D 35/306; B01D 2265/00; B01D 29/0043

(57) ABSTRACT

A filter housing assembly includes a base plate, an adapter block, and a shroud. The base plate may be permanently installed in a fluid-conveying system of conduits. A filter member is secured to a filter-receiving formation such as a pipe nipple extending from the adapter block and the shroud is secured to the adapter block to cover and seal the filter member. The adapter block is releasably secured to the base plate. The arrangement facilitates insertion and removal of the filter housing assembly into and out of the fluid-conveying system of conduits by converting multiple junction points into a single junction point, at which a subassembly consisting of just the shroud and the adapter block are connected into the system.

### FIELD OF THE INVENTION

In general, the present disclosure relates to components that are located in-line in a system through which fluid flows. More particularly, the disclosure relates to components—e.g., inline filter assemblies—that have at least one inlet and one outlet by means of which fluid flowing through the system enters and exits the component.

### BACKGROUND OF THE INVENTION

There are many industrial and/or manufacturing processes in which various components can be installed in-line in a system through which gaseous or liquid fluid flows. For example, in the pharmaceutical industry, it is known to purify gases that are used in various processes by passing the gas through a highly selective filter, e.g., a hydrophobic filter with a pore size of 0.2 microns or less, which removes dust, microbes, bacteria, etc. Such a prior-art, gas-filtering filter housing assembly 10 is illustrated in FIG. 1.

The filter housing assembly 10 includes a cylindrical, hollow-core filter member 12, which is mounted to a filter-receiving formation, e.g., a pipe nipple 14. A gasket, O-ring, or other type of sealing member 16 is used to secure the filter member 12 to the pipe nipple 14 to ensure that gas flowing into the filter housing assembly 10 via flanged inlet 18 must flow through the filter member 12—e.g., by passing radially inwardly into the core of the filter member 12—before exiting the filter housing assembly 10 via flanged outlet 20.

The filter housing assembly 10 further includes a two-part housing, which housing includes a lower cup 22 and an upper, bell-shaped shroud 24. The cup 22 surrounds and supports the piping 26 conveying gas from the inlet 18 toward the filter member 12 and the piping 28 conveying gas from the filter member 12 toward the outlet 20. The shroud 24 surrounds the filter member 12 and mates with the cup 22 along joint line 30. More particularly, the shroud 24 abuts the cup 22 along upper and lower flanges 32, 34, respectively, with a gasket or other sealing member (not illustrated) disposed between the flanges 32, 34, and the shroud 24 is secured to the cup 22 by means, e.g., of a split-ring flange clamp 36.

The piping 38, 40 that conveys the gas to and from the filter housing assembly 10 also includes flanged fittings 42, 44, which mate with the flanged inlet 18 to the filter housing assembly 10 and flanged outlet 20 of the filter housing assembly 10, respectively, with gaskets or other sealing members (not illustrated) disposed between the various flanges. The flanges may be secured together by split-ring flange clamps (not illustrated).

It is not uncommon to sterilize the filter member 12 using steam delivered to the filter housing assembly through either the inlet 18 or the outlet 10. Therefore, a flanged drain outlet 46 is provided at the bottom of the filter housing assembly 10 for condensate to drain from the filter housing assembly 10. In this regard, flange 48 of the flanged outlet 46 mates with flange 50 of drain pipe 52, with a gasket or other sealing member (not illustrated) disposed between the flanges 48 and 50 and a split-ring flange clamp (not illustrated) securing the flanges 48 and 50 together.

Before the filter housing assembly 10 can be used, the integrity of the seal between the filter member 12 and the pipe nipple 14, as well as the integrity of the filter member 12 itself, must be pressure-tested, e.g., on a test bench. If the seals are secure, the assembly 10 is then inserted into the gas-flow pathway, i.e., by positioning it between the flanged fittings 42, 44 on the gas-flow piping 38, 40, respectively, with the flanged inlet 18 and the flanged outlet 20 being maneuvered into position to mate with the fittings 42, 44 respectively. Additionally, if it is present, the flanged drain outlet 46 must be maneuvered into position such that the flange 48 of the outlet 46 is able to mate with the flange 50 of the drain pipe 52. Simultaneously, the gaskets or other sealing members used to seal the flange-to-flange joints must be positioned between the mating flanges, and the split-ring flange clamps must be positioned around the joints and tightened to secure the filter housing assembly 10 in position in the gas-flow pipeline.

After the purifying process for which the filter housing assembly 10 has been used is completed, the integrity of the seal between the filter member 12 and the pipe nipple 14, as well as the integrity of the filter member 12 itself, must be pressure-tested on the test bench once again. This is to ensure that the integrity of the seals and the filter member has maintained throughout the purifying process and that no contaminants were introduced into the filter housing assembly or the gas-flow piping. Therefore, the flange clamps are removed and the filter housing assembly 10 is removed from the gas-flow pathway.

Because the gas-flow piping is typically stainless steel and not very flexible as well as being rigidly secured in its gas-run position, maneuvering the filter housing assembly 10 into position and out of position at the beginning and end of the process in connection with which it is used can be difficult. Additionally, aligning the various flanges and properly positioning the gaskets or other sealing members between them can be challenging.

### SUMMARY OF THE INVENTION

The present disclosure features a filter housing assembly that is configured to overcome the above-noted difficulties associated with prior-art filter assemblies. Thus, in one aspect, a filter housing assembly includes a base plate having a first fluid inlet conduit and a first fluid outlet conduit. The base plate conduits extend from a lower surface of the base plate to an upper surface of the base plate on an opposite side thereof. The filter housing assembly further includes an adapter block this is releasably secured to the base plate. The adapter block has a second fluid inlet conduit and a second fluid outlet conduit, both of which extend from a lower surface of the adapter block to an upper surface on an opposite side thereof. The adapter block also has a filter-receiving formation located at the upper surface of the adapter block. Further still, the filter housing assembly includes a generally bell-shaped shroud having an open end.

The second fluid inlet conduit and the second fluid outlet conduit are arranged within the adapter block such that openings thereof at the lower surface of the adapter block will be aligned with respective openings of the first fluid inlet conduit and the first fluid outlet conduit at the upper surface of the base plate when the adapter block and the base plate are mated together during installation of the filter housing assembly into the gas-flow pathway. This establishes a continuous, combined inlet conduit and a continuous, combined outlet conduit, both extending from the lower surface of the base plate to the upper surface of the adapter block. Additionally, the open end of the shroud is configured to mate with and establish a seal with the upper surface of the adapter block.

In embodiments of the filter housing assembly, the filter-receiving formation may include a centrally located pipe nipple formed as an extension of the second outlet conduit that extends above the upper surface of the adapter block. Additionally, the base plate and the adapter block may have mutually cooperating keying features to ensure proper angular alignment of the adapter block relative to the base plate. For example, a post extending from the upper surface of the base plate may be configured to mate with a recess formed in the lower surface of the adapter block (or vice versa). Further still, the upper surface of the base plate may have formations surrounding the openings of the first inlet conduit and the first outlet conduit, while the lower surface of the adapter block may have formations surrounding the openings of the second inlet conduit and the second outlet conduit. The formations may be configured to receive and sandwich therein sealing gaskets. Preferably, the upper surface of the base plate may have a bypass slot extending between regions surrounding the openings of the first inlet conduit and the first outlet conduit and further extending to a side, peripheral portion of the upper surface of the base plate.

Further still, the upper surface of the base plate and the lower surface of the adapter block may each have a flange extending around the periphery thereof to facilitate securing the adapter block to the base plate my means of a split-ring flange clamp. Similarly, the upper surface of the adapter block and the open end of the shroud may each have a flange extending around the periphery thereof to facilitate securing the shroud to the adapter block by means of a split-ring flange clamp.

With this configuration, the base plate does not have to be removed to install or uninstall filter members. Rather, just the upper portion of the filter housing assembly including the shroud and the adapter block needs to be removed. This is far simpler than trying to “break apart” the assembly at three separate junction points.

In another aspect, the invention features a manufacturing installation. The manufacturing installation has a fluid-conducting run of piping with an inlet pipe and an outlet pipe, and a filter housing assembly like that described above installed within the run of piping. More specifically, according to this aspect of the invention, the base plate is permanently installed within the fluid-conducting run of piping with the inlet pipe being in permanent communication with the first fluid inlet conduit in the base plate and the outlet pipe being in permanent communication with the first fluid outlet conduit in the base plate.

Specific embodiments of this aspect of the invention may have the same features as those enumerated above.

In yet another aspect, the invention features a method of installing a filter member into a permanently installed, fluid-conducting run of piping having an inlet pipe and an outlet pipe. The method includes attaching the filter member to a filter-receiving formation extending from an upper surface of an adapter block, which adapter block has a pair of conduits extending through it from the upper surface to a lower surface thereof. The open end of a shroud is secured to the upper surface of the adapter block so as to enclose the filter member inside of the shroud, and then the lower surface of the adapter block is secured to the upper surface of a base plate. The base plate has a pair of conduits extending through it from the upper surface thereof to a lower surface thereof, and the base-plate conduits are permanently connected to respective ones of the inlet pipe and the outlet pipe. The adapter block is then temporarily secured to the base plate at a single, releasable junction point. As noted above, this greatly simplifies installing the filter member into or removing the filter member from the fluid-conducting run of piping.

In a further aspect, the invention features a method of removing a filter member from a permanently installed, fluid-conducting run of piping having an inlet pipe and an outlet pipe. The filter member is contained within a filter housing assembly, which includes an adapter block and a shroud secured to the adapter block. The method includes releasing a single securing mechanism by which the filter housing assembly is releasably secured to an upper surface of a base plate, and withdrawing the filter housing assembly from the base plate. The base plate has a pair of conduits extending through it from an upper surface thereof to a lower surface thereof, with the base-plate conduits being permanently connected to respective ones of the inlet pipe and the outlet pipe. This simplifies removal of the filter member from the fluid-conducing piping, as just a single point of connection needs to be undone.

### BRIEF DESCRIPTION OF THE DRAWINGS

These and other features of the invention will become clearer from the detailed description below as well as the drawings, in which:

FIG. 1 is a schematic diagram illustrating a filter housing assembly according to the prior art;

FIG. 2A is a three-dimensional rendering of a filter housing assembly according to one aspect of the invention; FIG. 2B is a side elevation view of the filter housing assembly shown in FIG. 2A; and FIG. 2C is a sectioned view of the filter housing assembly showing in FIG. 2A;

FIG. 3 is a sectioned view illustrating the mating arrangement of two components of the filter housing assembly shown in FIGS. 2A-2C;

FIG. 4A is a three-dimensional rendering of a base plate illustrated in FIG. 3 and used in connection with the filter housing assembly shown in FIGS. 2A-2C; FIG. 4B is a plan view of the base plate shown in FIG. 4A; FIG. 4C is a sectioned view taken along the view lines 4C-4C in FIG. 4B; and FIG. 4D is a sectioned view taken along the view lines 4D-4D in FIG. 4B;

FIG. 5A is a three-dimensional rendering of an adapter block, as viewed from above, illustrated in FIG. 3 and used in connection with the filter housing assembly shown in FIGS. 2A-2C; FIG. 5B is a three-dimensional rendering of the adapter block, as viewed from below; FIG. 5C is a plan view of the base plate shown in FIGS. 5A and 5B; and FIG. 5D is a sectioned view taken along the view lines 5D-5D in FIG. 5C;

FIG. 6 shows the base plate illustrated in FIGS. 4A-4D with gas-conducting piping joined to it;

FIG. 7A is a three-dimensional rendering of a shroud used in connection with the filter housing assembly shown in FIGS. 2A-2C; and FIG. 7B is a sectioned view of the shroud shown in FIG. 7A; and

FIGS. 8A and 8B are a sectioned side view and a top view, respectively, illustrating an alternate embodiment of a filter housing assembly according to the invention.

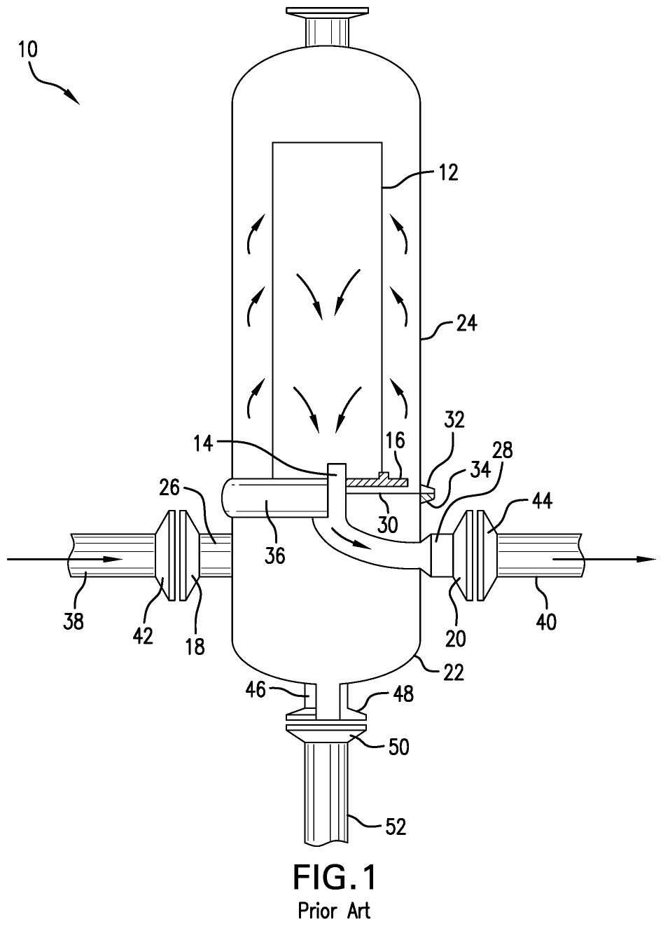

### DETAILED DESCRIPTION OF EMBODIMENTS OF THE INVENTION

In one embodiment, there is provided a filter housing assembly, comprising a base plate including a first fluid inlet conduit and a first fluid outlet conduit, both of which extend from a lower surface of the base plate to an upper surface of the base plate on an opposite side thereof; an adapter block including a second fluid inlet conduit and a second fluid outlet conduit, both of which extend from a lower surface of the adapter block to an upper surface of the adapter block on an opposite side thereof, and a filter-receiving formation located at the upper surface of the adapter block; and a generally bell-shaped shroud having an open end; wherein the second fluid inlet conduit and the second fluid outlet conduit are arranged within the adapter block such that openings thereof at the lower surface of the adapter block will be aligned with respective openings of the first fluid inlet conduit and the first fluid outlet conduit at the upper surface of the base plate when the adapter block and the base plate are mated together so as to establish a continuous, combined inlet conduit and a continuous, combined outlet conduit both extending from the lower surface of the base plate to the upper surface of the adapter block; and wherein the open end of the shroud is configured to mate with and establish a seal with the upper surface of the adapter block.

In another embodiment, the filter-receiving formation comprises a centrally located pipe nipple formed as an extension of the second outlet conduit that extends above the upper surface of the adapter block.

In still another embodiment, the base plate and the adapter block have mutually cooperating keying features to ensure proper angular alignment of the adapter block relative to the base plate.

In yet another embodiment, the keying features comprise a post extending from the upper surface of the base plate and a mating recess formed in the lower surface of the adapter block.

In one embodiment, the upper surface of the base plate has formations surrounding the openings of the first inlet conduit and the first outlet conduit; the lower surface of the adapter block has formations surrounding the openings of the second inlet conduit and the second outlet conduit; and the formations on the upper surface of the base plate and the lower surface of the adapter block are configured to sandwich sealing gaskets therebetween.

In another embodiment, the upper surface of the base plate has a bypass slot extending between regions surrounding the openings of the first inlet conduit and the first outlet conduit and further extending to a side, peripheral portion of the upper surface of the base plate.

In one embodiment, the upper surface of the base plate and the lower surface of the adapter block each have a flange extending around the periphery thereof to facilitate securing the adapter block to the base plate my means of a split-ring flange clamp.

In another embodiment, the upper surface of the adapter block and the open end of the shroud each have a flange extending around the periphery thereof to facilitate securing the shroud to the adapter block by means of a split-ring flange clamp.

In an alternative embodiment, there is provided a manufacturing installation, comprising a fluid-conducting run of piping having an inlet pipe and an outlet pipe; a base plate including a first fluid inlet conduit and a first fluid outlet conduit, both of which extend from a lower surface of the base plate to an upper surface of the base plate on an opposite side thereof, wherein the base plate is permanently installed within the fluid-conducting run of piping with the inlet pipe being in permanent communication with the first fluid inlet conduit in the base plate and the outlet pipe being in permanent communication with the first fluid outlet conduit in the base plate; an adapter block including a second fluid inlet conduit and a second fluid outlet conduit, both of which extend from a lower surface of the adapter block to an upper surface of the adapter block on an opposite side thereof, and a filter-receiving formation located at the upper surface of the adapter block; and a generally bell-shaped shroud having an open end. The second fluid inlet conduit and the second fluid outlet conduit are arranged within the adapter block such that openings thereof at the lower surface of the adapter block will be aligned with respective openings of the first fluid inlet conduit and the first fluid outlet conduit at the upper surface of the base plate when the adapter block and the base plate are mated together in an as-properly-assembled configuration so as to establish a continuous, combined inlet conduit and a continuous, combined outlet conduit both extending from the lower surface of the base plate to the upper surface of the adapter block, and the open end of the shroud is configured to mate with and establish a seal with the upper surface of the adapter block.

In some embodiments, the filter-receiving formation for the manufacturing installation comprises a centrally located pipe nipple formed as an extension of the second outlet conduit that extends above the upper surface of the adapter block.

In still another embodiment, the base plate and the adapter block for the manufacturing installation have mutually cooperating keying features to ensure proper angular alignment of the adapter block relative to the base plate. The keying features may comprise a post extending from the upper surface of the base plate and a recess formed in the lower surface of the adapter block.

In one embodiment, the upper surface of the base plate for the manufacturing installation has formations surrounding the openings of the first inlet conduit and the first outlet conduit, and the lower surface of the adapter block has formations surrounding the openings of the second inlet conduit and the second outlet conduit. The formations on the upper surface of the base plate and the lower surface of the adapter block are configured to sandwich sealing gaskets therebetween.

In another embodiment, the upper surface of the base plate has a bypass slot extending between regions surrounding the openings of the first inlet conduit and the first outlet conduit and further extending to a side, peripheral portion of the upper surface of the base plate. The upper surface of the base plate and the lower surface of the adapter block may each have a flange extending around the periphery thereof to facilitate securing the adapter block to the base plate my means of a split-ring flange clamp.

In still another embodiment, the upper surface of the adapter block and the open end of the shroud each have a flange extending around the periphery thereof to facilitate securing the shroud to the adapter block by means of a split-ring flange clamp.

In another embodiment, there is provided a method of installing a filter member into a permanently installed, fluid-conducting run of piping having an inlet pipe and an outlet pipe, the method comprising the steps of: (1) attaching the filter member to a filter-receiving formation located at an upper surface of an adapter block, the adapter block having a pair of conduits extending through it from the upper surface to a lower surface thereof; (2) securing an open end of a shroud to the upper surface of the adapter block so as to enclose the filter member inside of the shroud; (3) mating the lower surface of the adapter block to an upper surface of a base plate, which base plate has a pair of conduits extending through it from the upper surface thereof to a lower surface thereof with the base-plate conduits being permanently connected to respective ones of the inlet pipe and the outlet pipe; and (4) releasably securing the adapter block to the base plate.

In a separate alternative embodiment, there is provided a method of removing a filter member from a permanently installed, fluid-conducting run of piping having an inlet pipe and an outlet pipe, the filter member being contained within a filter housing assembly comprising an adapter block and a shroud secured to the adapter block, the method comprising the steps of (1) releasing a single securing mechanism by which the filter housing assembly is releasably secured to an upper surface of a base plate, which base plate has a pair of conduits extending through it from an upper surface thereof to a lower surface thereof with the base-plate conduits being permanently connected to respective ones of the inlet pipe and the outlet pipe; and (2) withdrawing the filter housing assembly from the base plate.

In the following portion of this disclosure, the last two digits of each reference numeral identify a given component, element, or algorithm step, and the preceding one or two digits of each reference numeral correspond(s) to the number of the figure in which the element or step is depicted. Thus, if a given element is shown in multiple figures, strictly speaking, the element will have different reference numerals in each of the several figures; however, the last two digits will be the same across all related figures being discussed at the same time in order to explain a particular concept or aspect of embodiments of the invention. If multiple figures are being addressed at the same time within this disclosure, just the reference numeral used in the lowest-numbered figure will be used in the text. Furthermore, different elements that are illustrated in different figures, which are discussed at different points within this disclosure, may have reference numerals in which the last two digits are the same; the fact that the elements are being discussed at different points in the disclosure should, however, prevent such commonality of the last two reference-numeral digits from causing confusion.

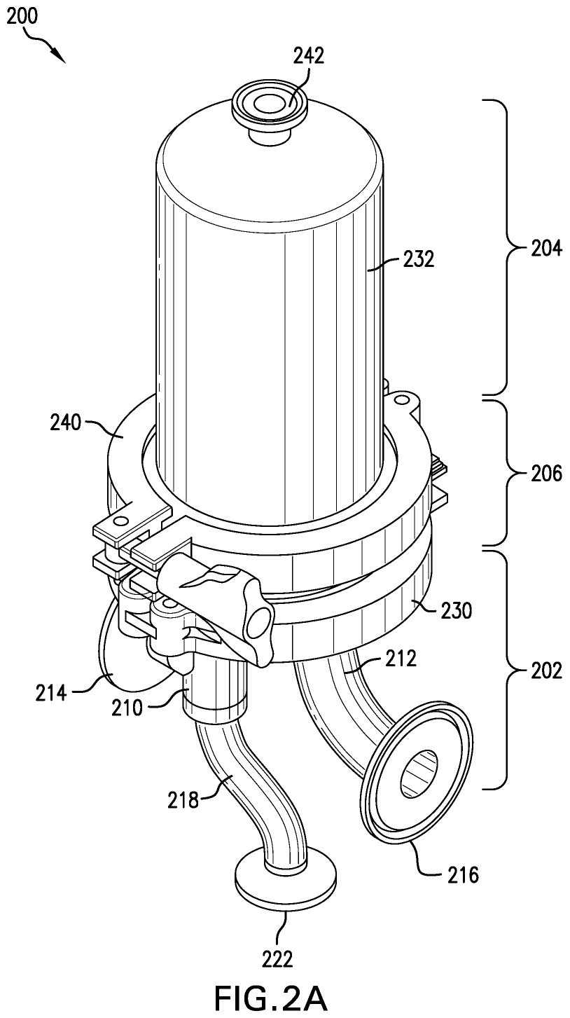

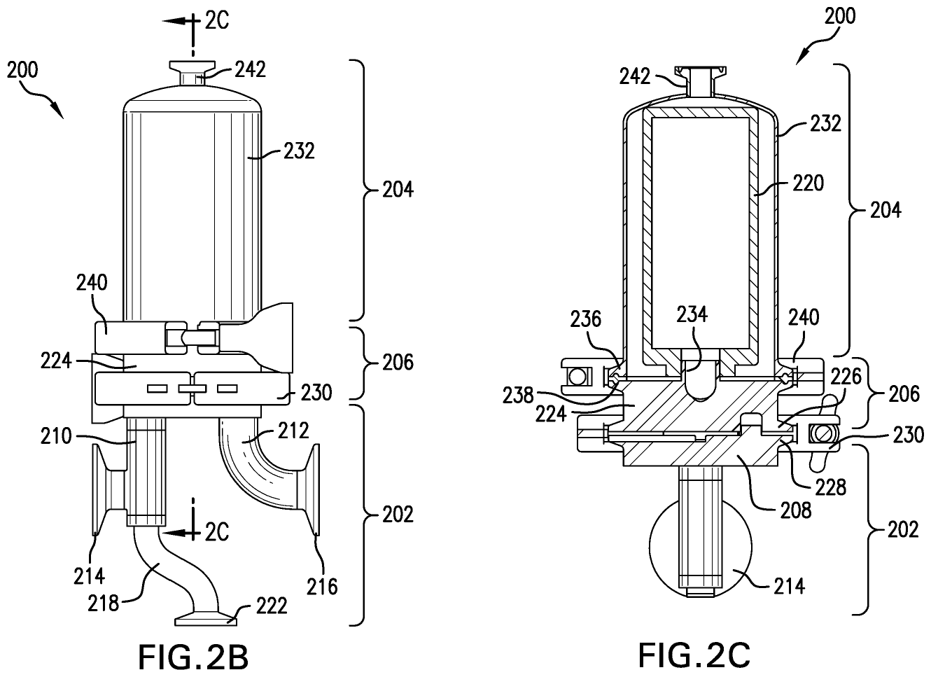

A filter housing assembly in accordance with the invention is illustrated in FIGS. 2A through 7B. As shown in FIGS. 2A, 2B, and 2C, filter housing assembly 200 includes a lower, connection portion 202 by means of which the filter housing assembly 200 is connected into a fluid-conveying system of conduits (not illustrated); an upper, filter portion 204; and an intermediate, adapter portion 206 by means of which the filter portion 204 is releasably mated with the connection portion 202.

In general, the connection portion 202 includes a stainless-steel base plate 208 (described in greater detail below), along with an inlet pipe 210 and an outlet pipe 212 extending downwardly from the base plate 208. The inlet pipe 210 and the outlet pipe 212 each include a flanged fitting 214, 216, respectively, by means of which the inlet pipe 210 and the outlet pipe 212 are connected to conduits (not illustrated) conveying fluid to and from the filter housing assembly 200. Additionally, a drain outlet pipe 218, to carry away condensate from steam sterilization of the filter member 220, may also be provided, e.g., by branching off and extending downwardly from the inlet pipe 210. Like the inlet pipe 210 and the outlet pipe 212, the drain outlet pipe 218 includes a flanged fitting 222 by means of which the drain outlet pipe 218 is connected to a drain line (not illustrated). Advantageously, because the adapter portion 206 permits the filter portion 204 to be releasably mated with the connection portion 202, the connection portion 202 can be permanently connected into the fluid-conveying system of conduits, e.g., by welding the flanged fittings 214 and 216 and, if present, 222 to mating flanges on the adjoining conduits (not illustrated).

In general, the adapter portion 206 primarily includes a stainless steel adapter block 224, which is described in greater detail below. The adapter block 224 abuts, and is configured to mate with, the base plate 208. The adapter block 224 and the base plate 208 each have a circumferential flange 226, 228, respectively, which engage with each other, and the adaptor block 224 is releasably secured to the base plate 208 by means of split-ring flange clamp 230.

In general, the filter portion 204 includes a stainless steel, generally bell-shaped shroud 232, which houses the cylindrical, hollow-core filter member 220. The filter member 220 is, for example, a highly selective filter, e.g., a hydrophobic filter with a pore size of 0.2 micron or less. The filter member 220 engages with a filter-receiving formation on the adapter block 224, e.g., a centrally located pipe nipple 234 that extends upwardly from the adapter block 224, and a gasket or other sealing member (not separately illustrated) is provided to secure the filter member 220 to the pipe nipple 234 to ensure that gas flowing into the filter housing assembly 200 must flow through the filter member 220—e.g., by passing radially inwardly into the core of the filter member 220—before exiting the filter housing assembly 200. Suitably, the shroud 232 is dimensioned so as to leave a small gap between it and the upper portions of the filter member 220, as illustrated in FIG. 2C. This holds the filter member 220 securely in position over the pipe nipple 234.

The lower, open end of the shroud 232 has a circumferential flange 236, and the upper portion of the adapter block 224 also has a circumferential flange 238. The flange 236 of the shroud 232 mates with the flange 238 of the adapter block 224, and split-ring flange clamp 240 is use to releasably secure the shroud 232 to the adapter block 224.

Furthermore, the shroud 232 suitably includes a flanged fitting 242 at its upper end. This fitting 242 can be used to attach a manual valve (not illustrated) to relieve pressure within the shroud 232 or a pressure gauge (not illustrated) to monitor pressure within the filter housing assembly 200 during operation of the process in connection with which the filter housing assembly 200 is used.

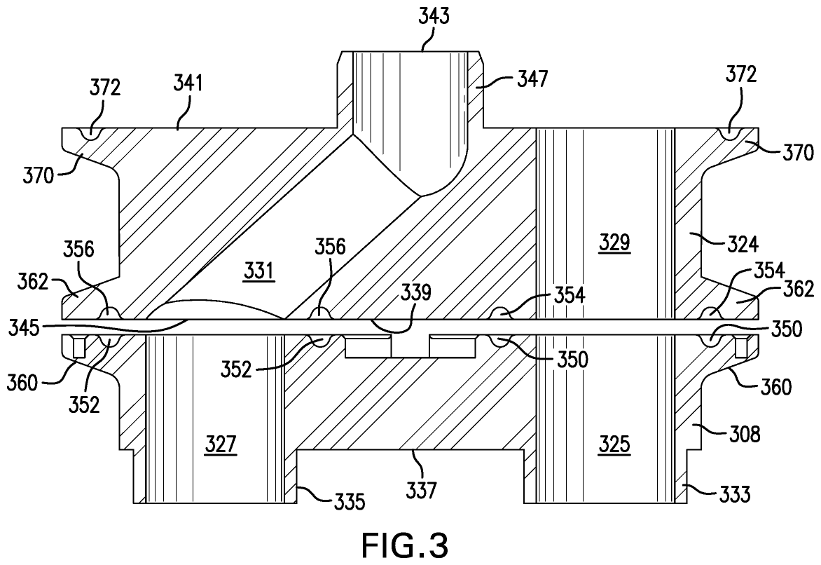

The base plate and adapter block are illustrated in greater detail in FIGS. 3, 4A-4D, and 5A-5D. As shown in FIG. 3, the base plate 308 and adapter block 324 are each generally puck-shaped, stainless steel members with a pair of conduits 325, 327 and 329, 331 (two inlet conduits and two outlet conduits) extending through them in their thickness directions.

The conduits 325 and 327 extending through the base plate 308 include cylindrical collars 333, 335 extending past the lower surface 337 of the base plate 308, and the inlet pipe 210 and outlet pipe 212 (FIG. 2) may be permanently attached to the cylindrical collars 333, 335, e.g., by welding them to the collars 333, 335. Suitably, the conduits 325 and 327 are aligned with each other along a diametric line, i.e., a line passing through the center of the base plate 308, and are equally spaced relative to the center of the base plate 308.

The conduit 329 extends through the adapter block 324 perpendicularly to the lower and upper surfaces 339, 341 of the adapter block 324, and it is spaced the same distance from the center of the adapter block 324 as the conduit 325 is spaced from the center of the base plate 308. As a result, the conduits 325 and 329 will be aligned with each other when the base plate 308 and adapter block 324 are positioned together as shown in FIG. 3, with their centers aligned and the base plate 308 and adapter block 324 properly positioned with respect to each other in terms of angular alignment. Together, assuming gas-flow is to be radially inward from the exterior into the interior of the filter member 220, the conduits 325 and 329 form the inlet pathway for gas flowing into the filter housing assembly. Suitably, the conduits 325 and 329 have the same internal diameters.

On the other hand, the conduit 331 extends at an angle from one opening 343, which is centrally located at the upper side of the adapter block 324, to another opening 345, which is located on the lower surface 339 of the adapter block 324. The opening 345 is aligned with the lower opening of the conduit 329 along a diametric passing through the center of the adapter block 324, and positioned the same distance from the center of the adapter block 324 as the lower opening of the conduit 329. In this manner, the conduit 327 will be aligned with the lower opening 345 of the conduit 331 when the base plate 308 and adapter block 324 are positioned together as shown in FIG. 3, with their centers aligned and the base plate 308 and adapter block 324 properly positioned with respect to each other in terms of angular alignment.

Further still, a cylindrical collar 347 extends from the upper surface 341 of the adapter block and surrounds and defines the opening 343 of the conduit 331. The cylindrical collar 347 serves as the filter-receiving formation (i.e., pipe nipple) on which the filter member 220 is to be mounted.

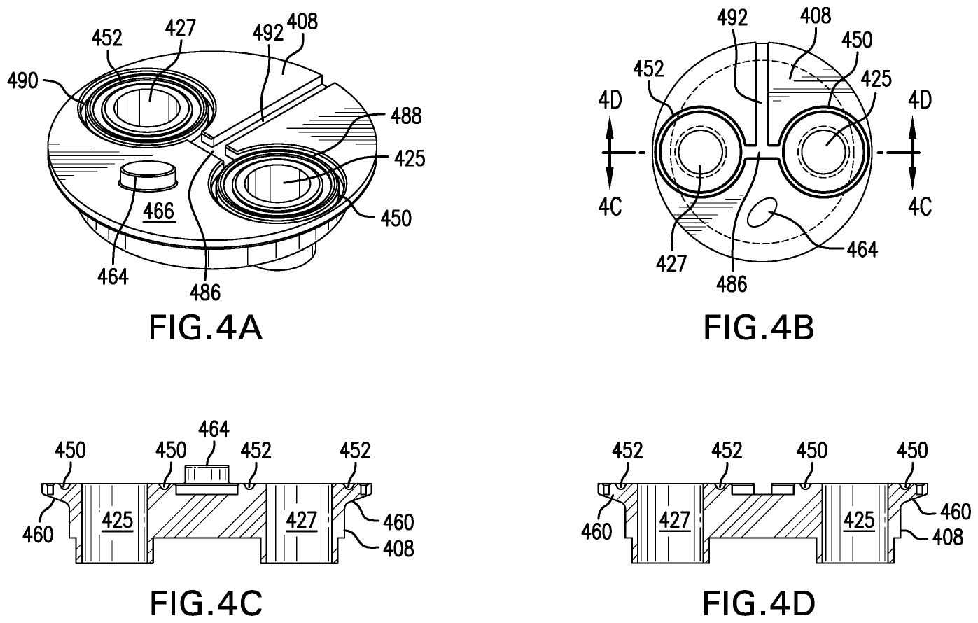

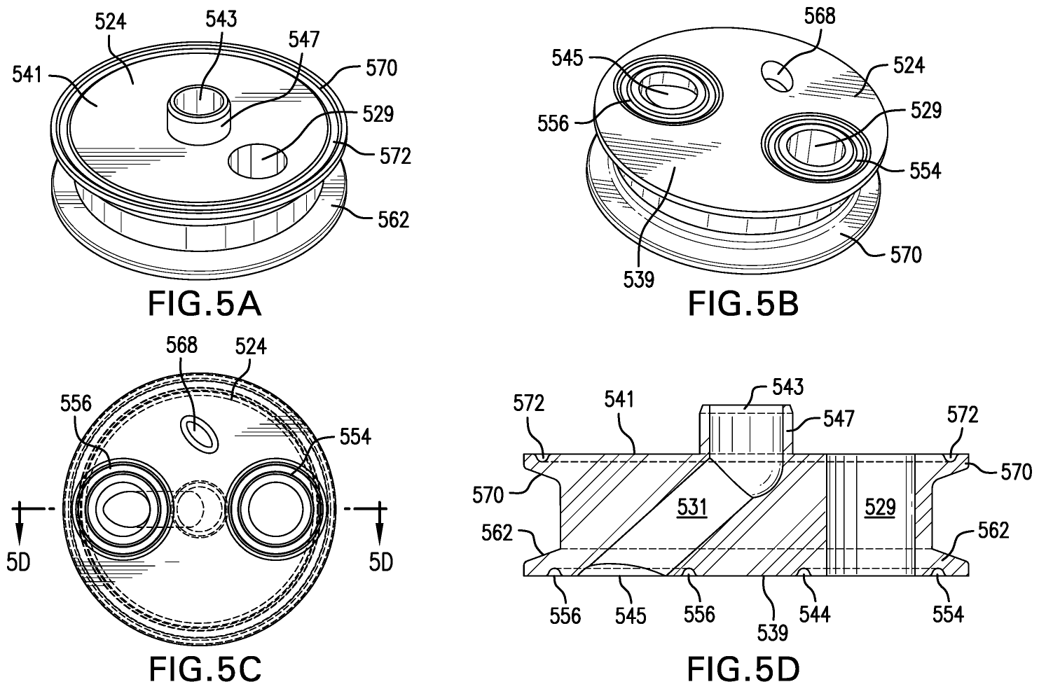

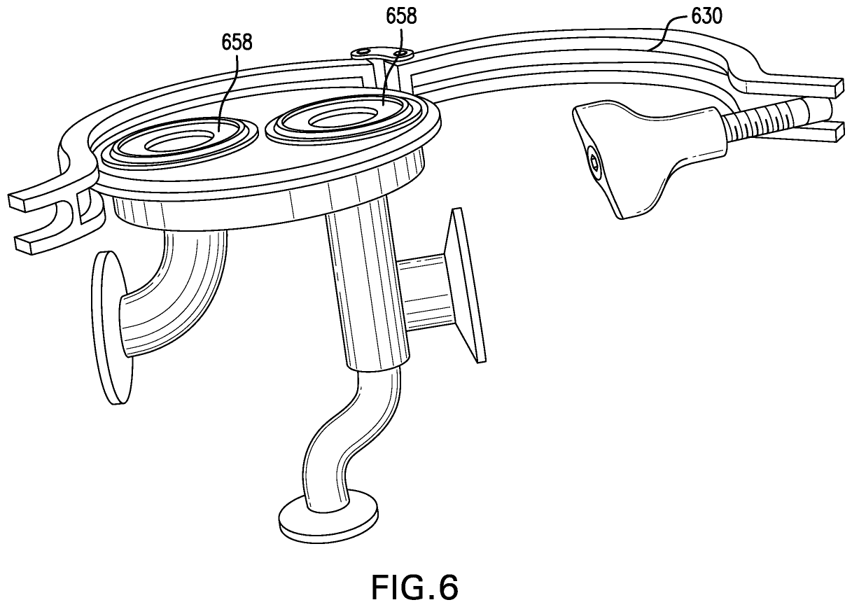

As further shown in FIG. 3 as well as in FIGS. 4A-4D and FIGS. 5B-5D, a circular groove 350, 352, 354, and 356 surrounds the opposing openings of each of the conduits 325, 327, 329, and 331, respectively. The grooves receive the annular bead around the outer periphery of a sealing gasket 658 (made, for example, from nylon, Teflon, silicone, etc.) that surrounds and seals each of the conduit openings, as shown in FIG. 6, when the base plate 308 and the adapter block 324 are mated together in the positions shown in FIG. 3. Furthermore, the base plate 308 has an annular flange 360 extending around its upper periphery, and the adapter block 324 has an annular flange 362 extending around its lower periphery. A split-ring flange clamp, only one of which 630 is shown in FIG. 6, fits over each of the two flanges 360, 362, as partially illustrated in FIG. 6, and is tightened in position to secure the adapter block 324 to the base plate 308.

Furthermore, the base plate and the adapter block include keying features to assure proper relative angular orientation of the base plate and the adapter block. For example, as shown in FIGS. 4A-4C and FIGS. 5B and 5C, the base plate 408 has a post-like projection 464 extending from its upper surface 466, and the adapter block 524 has a correspondingly shaped recess 568 formed in its lower surface 539 and into which the projection 464 fits. The projection 464 and recess 568 ensure that the base plate 408 and adapter block 524 are properly angularly aligned before they are clamped together. Other keying features such as aligning notches, index marks on the outer edges of the flanges 360 and 362, etc., could alternatively be provided.

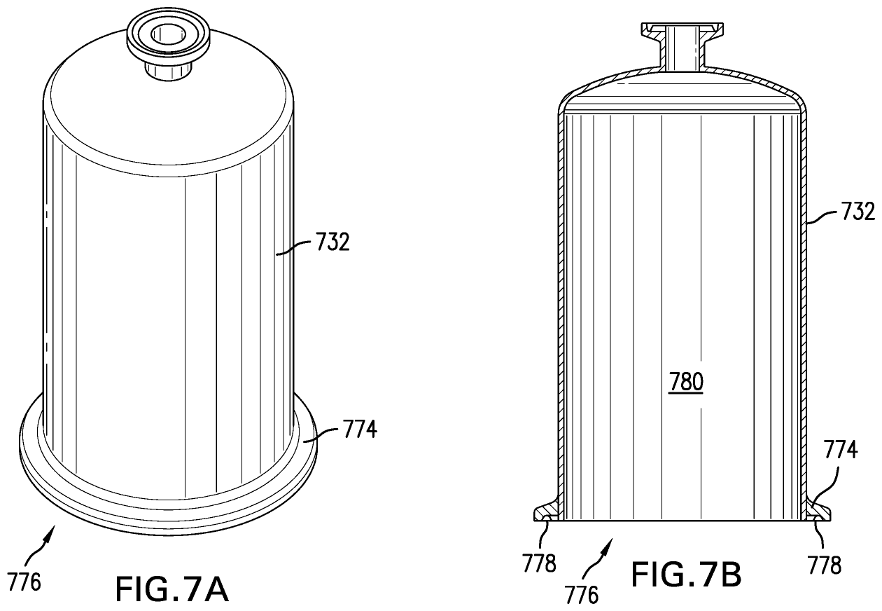

As further shown in FIGS. 3 and 5A, a flange 370 extends circumferentially around the periphery of the upper surface 341 of the adapter block 308, and a circumferentially extending groove 372 (572 in FIGS. 5A and 5D) is formed within the flange 370 (570 in FIGS. 5A, 5B, and 5D) to receive a sealing member such as an O-ring (not illustrated). Similarly, as shown in FIGS. 7A and 7B, a flange 774 extends circumferentially around the lower, open end 776 of the shroud 732. A circumferentially extending groove 778 is formed within the flange 774 to also receive the sealing member (e.g., O-ring) when the shroud 732 is engaged with the adapter block and clamped to it using a split-ring flange clamp 240, as illustrated in FIG. 2A. This seals the filter chamber 780 formed by the shroud 732.

Finally, as best illustrated in FIGS. 4A and 4B, a T-shaped slot 486, 492 is formed in the upper surface of the base plate 408. The cross-portion 486 of the T extends between circular channels 488, 490 that surround the sealing-gasket-receiving recesses surrounding the conduits 425, 427, and the stem 492 of the T extends from the cross-portion 486 of the T to the outer periphery of the base plate 408. The slot provides an outlet that allows gas to escape from the filter housing assembly in the event one or both of the sealing gaskets surrounding the conduits is/are not properly seated—gas will flow through the slot instead of through the filter member since the resistance of flowing through the filter member is significantly greater than the resistance of flowing along the slot—thereby preventing unfiltered gas from bypassing the filter member and contaminating components that are located downstream of the filter housing assembly.

A filter housing assembly in accordance with the invention simplifies preparation of the filter for use in an industrial or other manufacturing process. In particular, the filter member is secured to the filter-receiving formation (e.g., the pipe nipple extending from the upper surface of the adapter block); a sealing O-ring is placed in the groove extending around the upper flange of the adapter block; and the shroud is positioned over the filter member with the flange at the open, lower end of the shroud engaging with the O-ring. A split-ring flange clamp is then secured over the mating flanges of the shroud and the adapter block.

A subassembly consisting of just the shroud fitted to the adapter block (with the filter member installed inside of the shroud) is then mounted to a test bench (not illustrated), which has a fitting that emulates the upper surface of the base plate. The integrity of the seal between the filter member and the pipe nipple as well as the integrity of the filter member itself is then tested.

Once the integrity of the seal has been verified, the subassembly is removed from the test bench and installed inline by placing a pair of sealing gaskets on the upper surface of the base plate, surrounding each of the conduits extending through the base plate. (As noted above, the connection portion including the base plate may be permanently installed in the gas-run piping system.) The keying recess on the underside of the adapter block is aligned with the projection extending from the upper surface of the base plate, and the shroud/adapter block subassembly is brought into engagement with the base plate, with the gaskets sandwiched between the base plate and the adapter block and surrounding the conduits to seal the conduits. The shroud/adapter subassembly is then secured in engagement with the base plate using a split-ring flange clamp, as illustrated in FIGS. 2A, 2B, and 2C. Once the industrial process is complete, just the shroud/adapter subassembly needs to be removed from the base plate in order to retest and re-verify the integrity of the seal between the filter member and the filter-receiving formation (pipe nipple). In this manner, i.e., with just a single point of attachment/detachment between the portion of the filter housing assembly that includes the filter member and the portion of the filter housing assembly that conveys fluid to and from the filter member, insertion and removal of the filter housing assembly into and out of the fluid run is significantly easier than it is accordance with the prior art.

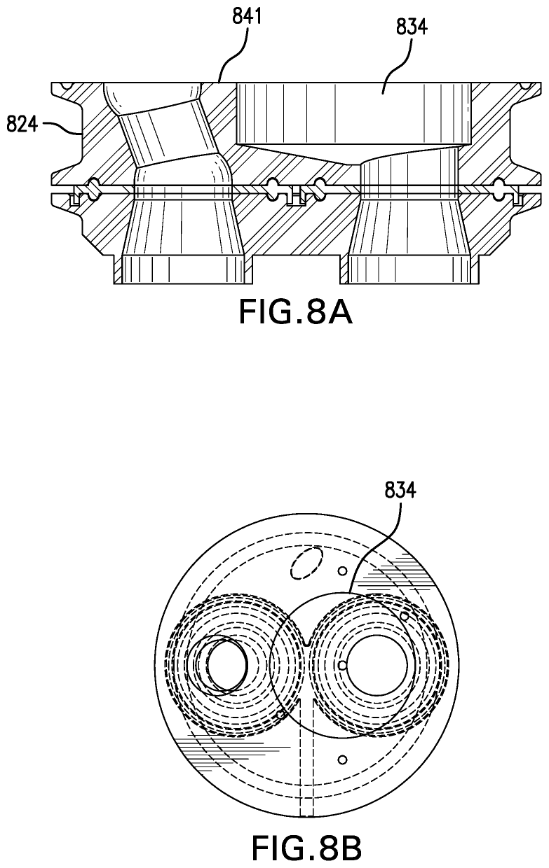

The foregoing disclosure is only intended to be exemplary of the methods and products of the present invention. Departures from and modifications to the disclosed embodiments may occur to those having skill in the art. For example, as illustrated in FIGS. 8A and 8B, the filter-receiving formation could be a socket-shaped depression 834 formed in the upper surface 841 of the adapter block 824, into which an end of the filter member (not illustrated) is firmly inserted. This configuration would be in contrast to the filter-receiving formation being formed as a pipe nipple. Operation of this embodiment is otherwise the same as operation of the embodiment illustrated and described above.

The scope of the invention is set forth in the following claims.

We claim:

1. A filter housing assembly, comprising:
a base plate including a first fluid inlet conduit and a first fluid outlet conduit, both of which extend from a lower surface of the base plate to an upper surface of the base plate on an opposite side thereof;
an adapter block including a second fluid inlet conduit and a second fluid outlet conduit, both of which extend from a lower surface of the adapter block to an upper surface of the adapter block on an opposite side thereof, and a filter-receiving formation located at the upper surface of the adapter block; and
a generally bell-shaped shroud having an open end;
wherein the second fluid inlet conduit and the second fluid outlet conduit are arranged within the adapter block such that openings thereof at the lower surface of the adapter block will be aligned with respective openings of the first fluid inlet conduit and the first fluid outlet conduit at the upper surface of the base plate when the adapter block and the base plate are mated together so as to establish a continuous, combined inlet conduit and a continuous, combined outlet conduit both extending from the lower surface of the base plate to the upper surface of the adapter block; and
wherein the open end of the shroud is configured to mate with and establish a seal with the upper surface of the adapter block.

2. The filter housing assembly of claim 1, wherein the filter-receiving formation comprises a centrally located pipe nipple formed as an extension of the second outlet conduit that extends above the upper surface of the adapter block.

3. The filter housing assembly of claim 1, wherein the base plate and the adapter block have mutually cooperating keying features to ensure proper angular alignment of the adapter block relative to the base plate.

4. The filter housing assembly of claim 3, wherein the keying features comprise a post extending from the upper surface of the base plate and a mating recess formed in the lower surface of the adapter block.

5. The filter housing assembly of claim 1, wherein
the upper surface of the base plate has formations surrounding the openings of the first inlet conduit and the first outlet conduit;
the lower surface of the adapter block has formations surrounding the openings of the second inlet conduit and the second outlet conduit; and
the formations on the upper surface of the base plate and the lower surface of the adapter block are configured to sandwich sealing gaskets therebetween.

6. The filter housing assembly of claim 1, wherein the upper surface of the base plate has a bypass slot extending between regions surrounding the openings of the first inlet conduit and the first outlet conduit and further extending to a side, peripheral portion of the upper surface of the base plate.

7. The filter housing assembly of claim 1, wherein the upper surface of the base plate and the lower surface of the adapter block each have a flange extending around the periphery thereof to facilitate securing the adapter block to the base plate my means of a split-ring flange clamp.

8. The filter housing assembly of claim 1, wherein the upper surface of the adapter block and the open end of the shroud each have a flange extending around the periphery thereof to facilitate securing the shroud to the adapter block by means of a split-ring flange clamp.

9. A manufacturing installation, comprising:
a fluid-conducting run of piping having an inlet pipe and an outlet pipe;
a base plate including a first fluid inlet conduit and a first fluid outlet conduit, both of which extend from a lower surface of the base plate to an upper surface of the base plate on an opposite side thereof, wherein the base plate is permanently installed within the fluid-conducting run of piping with the inlet pipe being in permanent communication with the first fluid inlet conduit in the base plate and the outlet pipe being in permanent communication with the first fluid outlet conduit in the base plate;
an adapter block including a second fluid inlet conduit and a second fluid outlet conduit, both of which extend from a lower surface of the adapter block to an upper surface of the adapter block on an opposite side thereof, and a filter-receiving formation located at the upper surface of the adapter block; and
a generally bell-shaped shroud having an open end;
wherein the second fluid inlet conduit and the second fluid outlet conduit are arranged within the adapter block such that openings thereof at the lower surface of the adapter block will be aligned with respective openings of the first fluid inlet conduit and the first fluid outlet conduit at the upper surface of the base plate when the adapter block and the base plate are mated together in an as-properly-assembled configuration so as to establish a continuous, combined inlet conduit and a continuous, combined outlet conduit both extending from the lower surface of the base plate to the upper surface of the adapter block; and
wherein the open end of the shroud is configured to mate with and establish a seal with the upper surface of the adapter block.

10. The manufacturing installation of claim 9, wherein the filter-receiving formation comprises a centrally located pipe nipple formed as an extension of the second outlet conduit that extends above the upper surface of the adapter block.

11. The manufacturing installation of claim 9, wherein the base plate and the adapter block have mutually cooperating keying features to ensure proper angular alignment of the adapter block relative to the base plate.

12. The manufacturing installation of claim 11, wherein the keying features comprise a post extending from the upper surface of the base plate and a recess formed in the lower surface of the adapter block.

13. The manufacturing installation of claim 9, wherein
the upper surface of the base plate has formations surrounding the openings of the first inlet conduit and the first outlet conduit;
the lower surface of the adapter block has formations surrounding the openings of the second inlet conduit and the second outlet conduit; and
the formations on the upper surface of the base plate and the lower surface of the adapter block are configured to sandwich sealing gaskets therebetween.

14. The manufacturing installation of claim 9, wherein the upper surface of the base plate has a bypass slot extending between regions surrounding the openings of the first inlet conduit and the first outlet conduit and further extending to a side, peripheral portion of the upper surface of the base plate.

15. The manufacturing installation of claim 9, wherein the upper surface of the base plate and the lower surface of the adapter block each have a flange extending around the periphery thereof to facilitate securing the adapter block to the base plate my means of a split-ring flange clamp.

16. The manufacturing installation of claim 9, wherein the upper surface of the adapter block and the open end of the shroud each have a flange extending around the periphery thereof to facilitate securing the shroud to the adapter block by means of a split-ring flange clamp.

17. A method of installing a filter member into a permanently installed, fluid-conducting run of piping having an inlet pipe and an outlet pipe, comprising:
attaching the filter member to a filter-receiving formation located at an upper surface of an adapter block, the adapter block having a pair of conduits extending through it from the upper surface to a lower surface thereof;
securing an open end of a shroud to the upper surface of the adapter block so as to enclose the filter member inside of the shroud;
mating the lower surface of the adapter block to an upper surface of a base plate, which base plate has a pair of conduits extending through it from the upper surface thereof to a lower surface thereof with the base-plate conduits being permanently connected to respective ones of the inlet pipe and the outlet pipe; and
releasably securing the adapter block to the base plate.

18. A method of removing a filter member from a permanently installed, fluid-conducting run of piping having an inlet pipe and an outlet pipe, the filter member being contained within a filter housing assembly comprising an adapter block and a shroud secured to the adapter block, the method comprising:
releasing a single securing mechanism by which the filter housing assembly is releasably secured to an upper surface of a base plate, which base plate has a pair of conduits extending through it from an upper surface thereof to a lower surface thereof with the base-plate conduits being permanently connected to respective ones of the inlet pipe and the outlet pipe; and
withdrawing the filter housing assembly from the base plate.
